(19) United States
(12) Patent Application Publication
(10) Pub. No.: US 2015/0070117 A1
(43) Pub. Date: Mar. 12, 2015

(54) ELIMINATING ANHYSTERETIC MAGNETISM IN FERROMAGNETIC BODIES

(71) Applicant: Albert Maurer, Gruet (CH)

(72) Inventors: Albert Maurer, Gruet (CH); Urs Meyer, Niederglatt (CH)

(21) Appl. No.: 14/478,298

(22) Filed: Sep. 5, 2014

(30) Foreign Application Priority Data
Sep. 6, 2013 (CH) 01531/13

(51) Int. Cl. H01F 13/00

(52) U.S. Cl. CPC H01F 13/006
USPC 335/284

(57) ABSTRACT

The aim is to improve the demagnetisation of ferromagnetic components by means of simple enhancements of a demagnetising device in such a manner that, in spite of the demagnetisation at approximately room temperature, ferromagnetic components with vanishingly low residual magnetism, as was previously only achievable by means of thermal demagnetisation, are achieved. This is achieved in that a chamber with walls made from magnetically highly-permeable ferromagnetic material for shielding from external interference fields, for example the magnetic field of the Earth, is used in the demagnetising coil of a demagnetising device, whereby an interference-field-free chamber interior is pushed with a reduction of the interference field strength in the chamber interior to such a small magnetic interference field, that the residual magnetism at the treated objects has a lower value after demagnetisation than the interference field outside of the chamber space.

### TECHNICAL FIELD

The present invention describes a use of a chamber with walls made from magnetically highly-permeable ferromagnetic material for shielding from external interference fields, for example the Earth's magnetic field, to achieve an interference-field-free chamber interior with a reduction of the interference-field strength in the chamber interior to less than half of the interference field strength outside of the chamber interior.

### PRIOR ART

Demagnetising methods aim to eliminate the residual magnetism located in a component or a module to such an extent that it does not appear as interference in subsequent processing operations or in later use.

Complete demagnetisation of ferromagnetic bodies is achieved by means of a thermal treatment using temperatures which lead to a transformation of the crystalline structure. Such a treatment is generally damaging in the case of semi-finished or finished products and is therefore not permitted.

Demagnetisation is therefore primarily effected at room temperature by means of a magnetic field, which flows through the object to be demagnetised with alternating polarity and with decreasing strength. These methods operating with magnetic fields have hitherto not been in the position however, to achieve a result fully equal to the thermal process.

The present invention relates to an improved magnetic method, which achieves a lower residual magnetism than the previously known apparatuses and methods of this type.

The aim of each demagnetising method is a final state of the material, which is as close as possible to zero for remanence and coercive field strength, respectively, within the hysteresis loop. Magnetic states within the hysteresis loop are designated anhysteretic. The bases for the magnetic properties of ferromagnetic materials can be drawn from the book “Magnetismus” by Dr. Otto Stemme, published 2004 by Maxon Academy Verlag, Sachseln, ISBN 3-9520143-3-8. A scientific presentation of anhysteretic material states with the associated models for derivation and calculation is published in the doctoral thesis of Jeremy Walker, University of South Florida, 2007, under the title “Measurement and modeling of the anhysteretic magnetization of magnetic cores for temperature and frequency dependent effects”.

The measurement of magnetomotive force and flux density in ferromagnetic material is only possible at the surface of a certain body, because any sensor introduced would cause interference in the internal magnetic field thereof. In particular, the states during the magnetisation (what is known as the initial magnetisation curve) and during demagnetisation (what is known as the commutation curve) and thus material behaviour in the anhysteretic region can only be determined using externally attached means and only for a homogeneous body.

An apparatus for determining the magnetic material properties is illustrated in FIG. 1 as a principle schematic. The characteristic curves for magnetomotive force and flux are determined in a closed magnetic circuit and constitute what is known as the hysteresis curve. The material sample 11 to be tested is in this case exposed to a variable magnetomotive force, and the resultant magnetic flux density is measured in a plane normal to the direction of the magnetomotive force when entering and exiting the material sample 11. The normal to this plane is used as reference direction 17 for the sign of the determined values for field strength and flux density. The magnetic circuit is closed by a yoke 12 made from magnetically conductive material. The coil 14 generates a magnetic flux 13 in the yoke 12, which penetrates the material sample 11. This flux is generated by the current 15 flowing through the coil 14. The magnetic properties of the material sample 11 can be determined and described on the basis of this current 15 and the voltage 16 arising at the coil.

To determine the hysteresis curve, a current 15 is alternately conducted through the coil 14 in both polarities in the device according to FIG. 1. The magnetic flux flowing through the material sample 11 is determined in a manner known per se by recording the voltage time interval on a test coil, which is not illustrated here and surrounds the material sample.

Magnetomotive force and magnetic flux are illustrated in the graph according to FIG. 2 as magnetic field strength and flux density, in each case with reference to the dimensions of the material sample. The graph shows the magnetic field strength H on the horizontal axis 21 and the magnetic flux density B on the vertical axis 22. On both axes, the zero point is located at the point of intersection 28 in each case. Positive and negative values relate to this, the sign relating to the direction 17 predetermined by the magnetic circuit.

The corresponding curve is termed a hysteresis curve. In this case, the following points or sections are characteristic. Point 28 characterises the completely unmagnetised state. The position of the remanence point 24 at magnetic field strength zero indicates the remanence flux density Br. The zone 25 corresponds to the state of magnetic saturation. The coercive point 26 represents the magnetic field strength at which the flux density is zero. This point indicates the coercive field strength Hc. The zone 29 or the point 27 on the characteristic curve section, which relates to the reversed direction of magnetic field strength or flux density correspond in terms of absolute value to the remanence point 24 or the coercive point 26. The experimentally determined hysteresis curves are fundamentally symmetrical, that is to say the determined values are identical in both directions.

The hysteresis curve constitutes the boundary line that can be assumed by the material in the relevant body. It surrounds the region of anhysteretic states, which are passed through during demagnetisation. Depending on the preceding curve of magnetomotive force and flux density, the material can take up any state within the hysteresis curve. This is shown using the example of the initial magnetisation curve 210, which leads from the completely unmagnetised state 28 to the hysteresis curve. The material passes through this initial magnetisation curve 210 during initial magnetisation from the completely demagnetised state.

If a ferromagnetic body is exposed to a surrounding magnetic field, a reciprocal influencing arises, as is shown in FIG. 4. The body 31 has a better conductance for the magnetic flux than the surroundings. The permeability thereof is higher. It accumulates the magnetic flux 32 in its surroundings, concentrates the same in the materials thereof and outputs the same back to the surroundings. This leads to a distortion of the surrounding field and to a magnetisation of the body at the same time. An increased magnetic flux density arises at the extremities of the body due to this mutual influencing. This phenomenon is termed induced magnetism. Induced magnetic poles arise at the relevant extremities.

In the report “Comparison of Stepwise Demagnetization Techniques” by T. M. Baynes, G. J. Russell and A. Bailey, published in IEEE Transactions on Magnetics, Vol. 38, No. 4, July 2002, pages 1753 ff., an initial curve and a commutation curve “anhysteretic (curve)” are shown by way of example in FIG. 4. The report is based on experimental tests for demagnetising ships, which were carried out on a reduced scale. In this case, a steel tube of 300 mm length and 32 mm external diameter was demagnetised using a coaxially surrounding coil. A corresponding set-up is shown schematically in FIG. 3. It corresponds to current technology, as is used for demagnetising components, modules and entire machines made from ferromagnetic material. The object 31 to be demagnetised is accommodated in the interior of a coil 34, which generates a demagnetising magnetic field 33 with alternating polarity and decreasing amplitude. The coil voltage 36 and the coil current 35 required for this are delivered by a current source with programmable amplitude and frequency, which is not contained in FIG. 3. The magnetic field 32 present in the surroundings, orientated coaxially to the coil axis in the illustration of FIG. 3, in reality has any desired direction. For example, this is the ubiquitously and constantly occurring magnetic field of the Earth. This magnetic field, which is superposed on the demagnetising field 33, is not taken into account in technical uses. The device shown fulfils the claims in many cases, but, as experiments have shown, does not result in a complete disappearance of the residual magnetism in object 31.

In the cited experiment of Baynes et al., a magnetic field existing transversely to the direction of the pipe was applied additionally and simultaneously, the same having two rectangular Helmholtz coils arranged on both sides of the tube and outside of the demagnetising coil. The desired goal of compensating the surrounding magnetic field of the Earth during the demagnetisation procedure using the interaction of the two coils was only achieved imperfectly. A complete demagnetisation of the steel tube was not successful. The demagnetisation process described in this literature is tailored for use on ships, in which a certain residual magnetism, which counteracts the magnetism induced by the Earth's field in the ship body, is to be imposed at the same time. The Helmholtz coils surrounding the tube are therefore loaded with a direct current, which generates this residual magnetism. The purpose and therefore also the method procedure do not correspond to the aim of completely eliminating residual magnetism to the greatest extent possible. The scientific result shown is that the number of steps with alternating polarity and decreasing amplitude up to at least the number 80 has a direct influence on the residual magnetism.

A refinement in terms of circuit engineering of such a device does not result in a complete disappearance of residual magnetism, as is known from the report “Demagnetization of magnetically shielded rooms” by

F. Thiel, A. Schnabel, S. Knappe-Grüneberg, D. Stollfuss, and M. Burghoff, published in Review of Scientific Instruments 78, 035106 (2007). An improved demagnetisation process for highly permeable shielding sheets is described, which was developed on the basis of experiments. The circuit-engineering methods used in the process are
The replacement of the conventionally used variable-ratio transformer with a mains-frequency supply by an electronic power amplifier as power source.
An isolating transformer for supplying the demagnetising coil, which keeps the unavoidable direct-current portion (drift and offset) at the outlet of the power amplifier away from the demagnetising coil.
The control of this amplifier by a high-resolution A/D converter, digitally controlled for its part using a program, which allows a free choice of voltage shape, frequency and amplitude.
Further circuit elements, such as filters and attenuators for optimising and adapting the signal.

The results of the previously mentioned demagnetising process cannot be transferred to industrial uses:
The highly-permeable material (Mu metal) used in the experiment as object to be demagnetised occurs exceptionally rarely in industrial uses and cannot be compared with the materials, parts and modules typically present as object.
The means used in the experiment are not suitable for demagnetising components made from industry-standard ferromagnetic materials, because they do not demonstrate the necessary field strength therefor.
The sensors used in the experiment for the magnetic field are extremely sensitive, the desired values for the residual magnetic field are extremely low. However, the measurements take place inter alia by means of sensors, which are too large in terms of their dimensions at a comparatively large distance from the metal surface. The magnetic residual magnetic field directly at the surface of the material, which is decisive for industrial use, was not determined.
The criterion of a spectrum of 1 to 100 Hz for the magnetic residual noises used finally in the evaluation is in no way connected with the residual magnetism of technical parts, which is disruptive in production processes.

The determination of the material behaviour in the anhysteretic region is used for characterising stone samples with ferromagnetic behaviour on the basis of what is known as paleomagnetism. The device D-2000 from ASC Scientific, Carlsbad, California is for example used for this purpose. The measurement procedure is described in http://magician.ucsd .edu/Essentials_{—}2/WebBook2ch9. html#x11-10800210. The stone sample is either magnetised using a one-off current pulse through a surrounding coil along the hysteresis curve, or brought to a state in the anhysteretic region by cyclic, alternately directed current pulses. The residual magnetism measured following this treatment is used for characterising the stone sample. Even if the term demagnetisation is used, the method of treatment consists of imparting magnetism. The aids used for treating the stone samples are accordingly used not for elimination, but rather for generating magnetism.

The present invention is then applied in the case of the theoretical models, which are to be found in the previously cited scientific reports. It relates to a method for demagnetising ferromagnetic parts in the range of residual magnetism, which lies in and below the order of magnitude of the field of the Earth and can only be achieved according to the prior art by means of thermal demagnetisation.

### DESCRIPTION OF THE INVENTION

The object of the present invention is the demagnetisation of ferromagnetic components by means of simple enhancements of a demagnetising device. In spite of the demagnetisation at approximately room temperature, ferromagnetic components with such low residual magnetism as was previously only achievable by means of thermal demagnetisation are achieved.

### SHORT DESCRIPTION OF THE DRAWINGS

A preferred exemplary embodiment of the subject of the invention is described in the following in connection with the attached drawings.

FIG. 1 schematically shows a measuring apparatus for the hysteresis loop known from the prior art.

FIG. 2 shows a magnetic state characteristic curve (hysteresis curve) by way of example

FIG. 3 schematically shows a demagnetising device with air-core coil known from the prior art in a schematic view.

FIG. 4 schematically shows the influence of a surrounding magnetic field on a demagnetising device of the known type.

FIG. 5 schematically shows the action of a magnetic shielding of the surrounding magnetic field.

FIG. 6 shows the features according to the invention of shielding of the surrounding magnetic field in interaction with a demagnetising coil in a schematic view.

FIG. 7 shows a perspective view of a chamber with demagnetising coil.

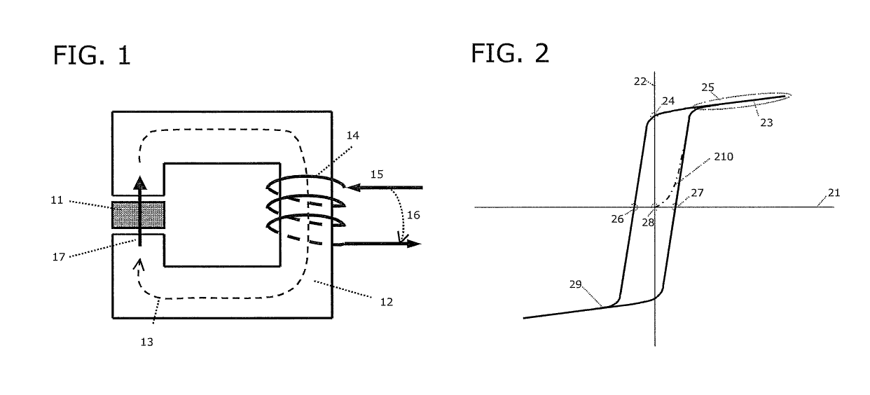

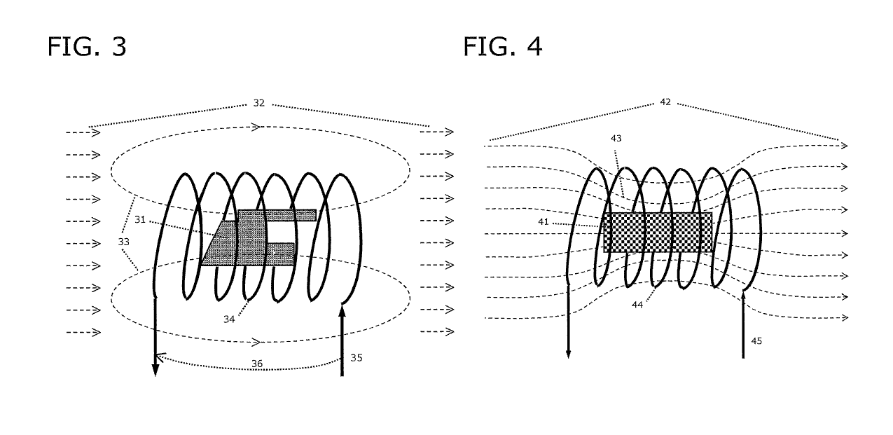

### DESCRIPTION

The magnetism existing in a geometrically delimited body made from ferromagnetic material is generally not evenly distributed. Differences in the flux density, which appear on the surface of the body in a punctiform manner, result due to the interaction between the magnetised body and the surroundings thereof. Such differences result for example due to the shape of the body itself, but also possibly due to inhomogeneities of the material present in the body.

For demagnetisation, the body is driven to saturation in a first phase by means of the demagnetising magnetic field applied from outside. In the process, all parts of the body pass through the hysteresis curve as far as the region of saturation. Any differences existing in various parts of the body are therefore compensated and the direction of the magnetism in the interior of the body is aligned. The thus-created material state is no longer determined by the previous history, but rather can be reproduced flawlessly. The demagnetising coil must be in a position with regards to the supply thereof, to create this saturation state everywhere in the body to be demagnetised. In the case of devices and installations used industrially, this is generally, but clearly not always accomplished.

In a second phase, the amplitude of the current acting in alternating directions is gradually decreased in the demagnetising pulses. With the multiple pass-throughs, the hysteresis loop of the whole body becomes smaller. This effect is explained by the division of the magnetic domains in the material into ever smaller units, which behave differently in terms of the alignment thereof. A sufficiently small decrement in the amplitude of the coil current is decisive for the action. Scientific publications and also operational experience demand a decrement of at most 1 . . . 2% per period. This is not fulfilled in a large portion of the devices and installations used in practice. Thus, freely decaying resonant circuits show a considerably larger decrement as a consequence of the resistance of the copper conductor of the coil and do not create a reproducible result during demagnetisation. Manually operated circuits, in which the coil current is set pulse by pulse individually in terms of the intensity and triggered, do not guarantee a reliable result. The decrement mentioned requires automatic control of the process and the feeding of electrical energy during the reduction of the current amplitude. Installations of this type are prior art and described inter alia in patent specification EP 1 465 217.

The demagnetising coil can however also be loaded solely by means of external supply with programmed frequency and voltage, as described in patent specification EP 179 1138.

When this second phase ends, the amplitude of the coil current tends towards zero and the current flow is ultimately terminated, a few interference effects arise, with considerable influence on the remaining residual magnetism. These are:

a) The external energy supply to the resonant circuit is terminated automatically when a predetermined time period is reached. A certain remaining degree of magnetism in the object must be taken into account in this case, given by the last continuous hysteresis loop in the anhysteretic region.

b) The external energy supply to the resonant circuit is terminated, because the actual-value detection for current and/or voltage and therefore the control loop responsible for the same reach the resolution limit thereof. Analogously to the case a), this determines a limit for the technically possible demagnetisation using the relevant apparatus.

c) The external energy supply generates a direct-current component in the current or voltage of the coil. This leads to asymmetry of the hysteresis loop that is passed through and thus necessarily generates a residual magnetism.

d) A magnetic field from a different source active in the area of the coil during the demagnetising process leads, analogously to case c), to asymmetry of the hysteresis loop passed through and generates a residual magnetism. An example for this is the magnetic field of the Earth.

By utilising circuit means, it is possible to eliminate the effects mentioned under a) to c) to such an extent that the residual magnetism falls below a value, which results solely under the influence of the field of the Earth as induced magnetism. The present invention now makes it possible to go even below this limit.

The description formulated in the following relates to objects 51, 61 to be demagnetised in the form of ferromagnetic bodies of dimensions as generally occur in general mechanical engineering, in steel construction, in toolmaking and in micromechanical components. The term ferromagnetic materials is understood in the following to also mean highly permeable and permanently magnetic materials. The materials can be amorphous or crystalline and be present both as a metal alloy and in ceramic form.

The relevant bodies can be present individually or in a multiplicity, ordered or disordered, aligned or in any direction, in a pack or connected to form a conglomerate, fixed on transport carriers or as loose bulk material. The relevant bodies can be of any desired shape, even composed of a plurality of parts. The material of the body can be homogeneous or have different properties in certain sections, at least one section having ferromagnetic properties.

The illustrations show the distribution of the magnetic flux under analogous conditions in a real body.

One possible demagnetisation device comprises at least one
demagnetising coil 54, 65 as air-core coil, consisting exclusively of non-ferromagnetic materials, the demagnetising coil 54, 65 surrounding the object 51, 61 to be demagnetised completely in all of the dimensions thereof.
power source for the air-core coil 54, 65 delivering a demagnetising pulse of known course and a direct-current component using circuit means exclusively.
passive shielding as a chamber made from highly permeable material, in various configurations. An interference field 52 surrounding the chamber runs as a surrounding magnetic field 53 within the walls of the chamber.

Features of the Method

Initially, the object 51, 61 to be demagnetised is introduced into the interior of the demagnetising coil 54, 65, which is located in the chamber. By means of the passive shielding action of the chamber made from highly permeable material, the chamber interior is free or virtually free from external interference fields. The magnetic field of the Earth, which acts as an interference field, is reduced considerably by the passive shielding within the chamber and ideally reduced to zero or forced out of the chamber interior through the highly permeable chamber walls. The interference field strength within the chamber is thereby reduced to approximately half or less of the field strength in an unshielded chamber.

The actual demagnetisation is carried out along a predetermined demagnetisation curve by applying an attenuating magnetic alternating field as demagnetising field within the demagnetising coil. A control and the course of the demagnetisation curve are preferably used, as is known from EP 179 1138 of the applicant.

The resulting demagnetising field in the demagnetising coil has an alternating temporal course, the amplitude decreasing towards zero in a certain number of periods. So that no residual magnetic fields are imposed, a direct-current component of the coil current is to be avoided whilst passing through the demagnetisation curve.

During the demagnetisation process, the scattering in of magnetic fields, interference fields, existing or generated externally onto the object to be demagnetised is virtually completely suppressed by the shielding.

Chamber Design

The walls of the chamber are produced from one or a plurality of layers of one or various highly permeable materials, with which external magnetic fields of any type are kept away at the object to be demagnetised in the chamber interior during the demagnetisation. The layer or the layers of the walls consist of magnetic-field-conducting material.

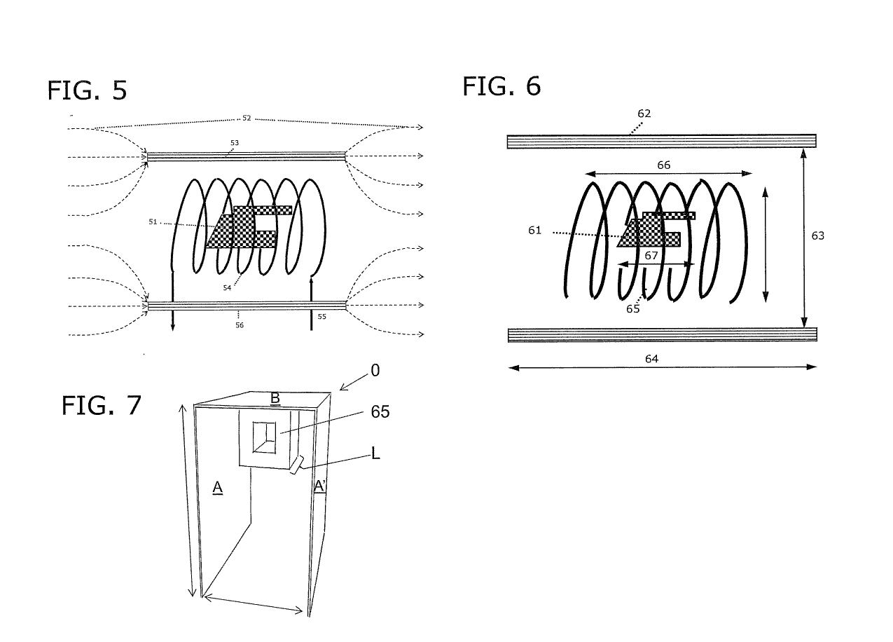

As shown schematically in FIG. 6, the demagnetising coil 65 is located inside the chamber, the internal dimensions 63, for example the spacing of the side faces 63 from one another, being configured in accordance with the dimensions of the demagnetising coil. The demagnetising coil 65 is configured and positioned in such a manner that the chamber walls overlap the demagnetising coil 65 in all directions. The objects 61 to be demagnetised must have lengths 67 of such a type that the same are completely surrounded by the demagnetising coil 65.

A special design of the chamber 0 is illustrated in FIG. 7. Two side walls A, A′ are connected to one another at a spacing a via a cover wall B, whereby a U-profile-shaped or cowl-like chamber 0 with three walls is achieved. A chamber 0 designed in such a manner can be can be installed with little installation outlay on an existing demagnetising device. Here, the side faces A, A′ are designed to be twice as long as the cover wall B, as a result of which a flux accumulation is achieved and the influence of interference fields is minimised.

The chamber can be designed with three to at most six side walls and therefore to be completely closed. The demagnetising coil 65 positioned in the chamber interior is therefore accessible either from the outside freely from one or two sides or from one side after opening a side wall. In the case of a chamber configured such that it can be opened or disassembled, the demagnetising coil 65 can be easily accessible for introducing objects 61 or else for maintenance or repair processes.

To achieve good demagnetisation results, the walls should be designed to be longer than the coil length L, so that the walls overlap the coil 65. It has proven to be advantageous that this overlap corresponds to at least half of the coil length L.

As an option, to shield the object 51, 61 to be demagnetised within the chamber, at least one layer of the chamber walls can be constructed from a material that conducts electricity well, particularly from copper, silver or aluminium. Eddy currents are built up in this at least one layer, which shield the chamber interior from magnetic alternating fields, as a result of which the residual magnetism in the object 51, 61 to be demagnetised can be reduced further.

### REFERENCE LIST

0 Chamber

11 Material sample

12 Magnetically conductive yoke

13 Path of the magnetic flux

14 Coil

15, 35, 45, 55 Coil current

16 Coil voltage

17 Reference direction for the magnetic field

21 X-axis, magnetic field strength H [A/m]

22 Y-axis, magnetic flux density B [Vs/m2]

23 Magnetically saturated zone

24 Hysteresis curve in the region of magnetic saturation

25 Region of magnetic saturation

26 Coercive field strength

27 Coercive field strength (reversed direction)

28 State of complete demagnetisation

29 Hysteresis curve (reversed direction)

210 Initial magnetisation curve

31, 41, 51, 61 Object to be demagnetised

32 Surrounding magnetic field

33 Demagnetising magnetic field

34, 44, 54 Demagnetising coil

36 Coil voltage

42 Surrounding, undisturbed magnetic field

43 Surrounding, distorted magnetic field

52 Surrounding, undisturbed magnetic field

53 Surrounding magnetic field in the shield

56 Shield

62 Shield

63 Internal dimension of the shield normal to the axis of the demagnetising coil

64 Length of the shield parallel to the axis of the demagnetising coil

65 Demagnetising coil

66 Length of the demagnetising coil

67 Length of the object to be demagnetised

A, A′ Side walls

a Spacing

B Cover wall

L Coil length

1. A method of using a chamber with walls made from magnetically highly-permeable ferromagnetic material for shielding from external interference fields, the walls configured to achieve an interference-field-free chamber interior with a reduction of an interior interference-field strength in the chamber interior to less than half of an exterior interference field strength outside of the chamber interior, the method comprising:
initiating a demagnetisation of a ferromagnetic component along a predetermined demagnetisation curve in a demagnetising coil within the chamber interior; and
during the demagnetisation of the ferromagnetic component, applying an attenuating magnetic alternating field within the demagnetising coil.

2. The method according to claim 1, wherein the walls of the chamber have at least one layer made from a material that conducts electricity well, particularly from copper, silver or aluminium.

3. The method according to claim 1, wherein the demagnetising coil is arranged in the chamber interior and fixed to the chamber.

4. The method according to claim 1, wherein extents of the walls project beyond an extent of the demagnetising coil, so that the walls of the chamber overlap the demagnetising coil.

5. The method according to claim 4, wherein the walls project beyond a length of the demagnetising coil.

6. The method according to claim 1, wherein the chamber has a shape of a U-profile, comprising two side walls connected via a cover wall.

7. The method according to claim 2, wherein the material that conducts electricity well comprises at least one of copper, silver and aluminium.

8. The method according to claim 1, wherein the external interference fields comprise Earth's magnetic field.

9. A demagnetisation chamber comprising:
walls made from magnetically highly-permeable ferromagnetic material and defining a chamber interior, the walls configured to shield from external interference fields to achieve an interior interference-field strength inside the chamber interior which is less than half of an exterior interference field strength outside of the chamber interior; and
a demagnetising coil within the chamber interior, the demagnetising coil configured to demagnetise a ferromagnetic component along a predetermined demagnetisation curve and configured to apply an attenuating magnetic alternating field during demagnetisation of the ferromagnetic component.

10. The demagnetisation chamber according to claim 9, wherein the walls of the demagnetisation chamber comprise at least one layer made from a material that conducts electricity well.

11. The demagnetisation chamber according to claim 10, wherein the material that conducts electricity well comprises at least one of copper, silver and aluminium.

12. The demagnetisation chamber according to claim 9, wherein the demagnetising coil is arranged in the chamber interior and fixed to the demagnetisation chamber.

13. The demagnetisation chamber according to claim 9, wherein extents of the walls project beyond an extent of the demagnetising coil, so that the walls of the demagnetisation chamber overlap the demagnetising coil.

14. The demagnetisation chamber according to claim 13, wherein the walls project beyond a length of the demagnetising coil.

15. The demagnetisation chamber according to claim 9, wherein the demagnetisation chamber has a U-profile shape, comprising two side walls connected via a cover wall.
